(19) United States
(12) Patent Application Publication
(10) Pub. No.: US 2007/0279551 A1
(43) Pub. Date: Dec. 6, 2007

(54) Backlight unit and liquid crystal display apparatus

(75) Inventor: Nobuhiro Umebayashi, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD.

(21) Appl. No.: 11/715,336

(22) Filed: Mar. 8, 2007

(30) Foreign Application Priority Data
May 30, 2006 (JP) 2006-179804
Oct. 16, 2006 (JP) 2006-281473

(51) Int. Cl. G02F 1/1335

(52) U.S. Cl. 349/65

(57) ABSTRACT

The backlight unit includes a light guide that receives light emitted from a LED through its end and reflects the light by a prism-shaped reflective groove to thereby output parallel light through an output surface, and a microlens array substrate that receives the parallel light output from the light guide through its side surface and reflects the light by a prism portion to thereby output the light to a liquid crystal display panel through a microlens array. The prism portion has a reflective groove that lies perpendicular to the propagation direction of the parallel light entering through the side surface. The microlens lies perpendicular to the reflective groove. A low refractive index layer is placed to the side of the microlens array.

### BACKGROUND OF THE INVENTION

1. Field of the Invention

The present invention relates to a backlight unit and a liquid crystal display apparatus and, particularly, to a backlight unit including a microlens array substrate and a light guide unit and a liquid crystal display apparatus including the backlight unit.

2. Description of Related Art

To develop a liquid crystal display apparatus with high brightness and a wide viewing angle, a technique of using a microlens array has been proposed. The technique places a microlens array substrate on the backside of a liquid crystal display panel to thereby focus backlight avoiding TFT devices and black matrixes formed on a transparent substrate of the liquid crystal display panel. This leads to an increase in light use efficiency to achieve high brightness.

Japanese Unexamined Patent Application Publication No. 8-166502 discloses a technique of forming a microlens array made of glass on a glass substrate. Specifically, this technique forms a microlens array by depositing a photosensitive glass paste film that is made up of glass powder and a photosensitive resin on a substrate and then performing exposure, development and heat treatment thereon.

Japanese Unexamined Patent Application Publication No. 10-333144 discloses a technique of placing a microlens array between a liquid crystal panel and a back light.

Japanese Unexamined Patent Application Publication Nos. 2006-114239 and 2004-227956 disclose a light guide plate that reflects the light incident through the side surface and propagating therethrough by a prism-shaped reflective groove toward the front surface and then outputs the reflected light through a plurality of lenses. However, the lens disclosed therein is not configured to focus backlight so as to avoid TFT devices and black matrixes formed on a transparent substrate of a liquid crystal display panel.

In order to increase the brightness of a liquid crystal display panel using a microlens formed on a light guide plate, it is necessary to apply highly directional light to a microlens and focus the light so as to accurately avoid TFT devices and black matrixes. However, the prism-shaped reflective groove formed on the bottom surface of the light guide plate should output the incident light evenly all over the front surface of the light guide plate. Specifically, it is necessary to guide the incident light toward the vicinity of the side surface of the light guide plate opposite to the incident side surface by repeatedly reflecting the incident light a plurality of times between the interface at the front surface and the reflective groove, rather than outputting the incident light through the front surface of the light guide plate by reflecting the incident light once by the first reflective groove. It is therefore unable to output highly directional light to the microlens through the front surface of the light guide plate by the reflective groove formed on the bottom surface of the light guide plate, which hinders an increase in the brightness of a liquid crystal display panel.

### SUMMARY OF THE INVENTION

The present invention has been accomplished with a view to solving the aforementioned problems, and an object of the invention is to provide a backlight unit capable of improving the brightness of a liquid crystal display panel and a liquid crystal display apparatus using the backlight unit.

According to one aspect of the present invention, there is provided a backlight unit provided at a backside of a liquid crystal display panel and including a microlens for focusing light on a transmissive area of each pixel of the liquid crystal display panel. The backlight unit includes a light guide for outputting parallel light output from the light guide through a side surface, reflecting the light by a first prism portion formed on a bottom surface, and outputting the light to the liquid crystal display panel through the microlens formed on a front surface. The microlens array substrate includes a microlens array including a plurality of microlenses; a transparent substrate including the first prism portion having a reflective groove lying perpendicular to a propagation direction of parallel light entering through the side surface; and a low refractive index layer provided between the microlens array and the transparent substrate and having a lower refractive index than the transparent substrate.

The backlight unit may further include a light source, and the light guide preferably receives light from the light source through an end, reflects the light by a second prism portion formed on one side surface, and outputs parallel light through a side surface opposite to the side surface on which the second prism portion is formed.

In the above backlight unit, the light source preferably includes a first light source provided at one end of the light guide, and a second light source provided at another end of the light guide.

In the above backlight unit, the side surface of the light guide on which the second prism portion is formed preferably has a curved structure with a projecting center.

Preferably, in the above backlight unit, the microlens is a cylindrical lens lying perpendicular to the reflective groove of the first prism portion.

The backlight unit may further include a polarizing plate or a polarizing layer provided between the low refractive index layer and the microlens array.

According to another aspect of the present invention, there is provided a liquid crystal display apparatus including a liquid crystal display panel including liquid crystal interposed between a pair of device substrates with electrodes formed on inner surfaces; and a backlight unit provided at a backside of the liquid crystal display panel. The backlight unit includes a light guide for outputting parallel light; and a microlens array substrate for receiving parallel light output from the light guide through a side surface, reflecting the light by a first prism portion formed on a bottom surface, and outputting the light to the liquid crystal display panel through a microlens formed on a front surface. The microlens array substrate includes a microlens array including a plurality of microlenses; a transparent substrate including the first prism portion having a reflective groove lying perpendicular to a propagation direction of parallel light entering through the side surface; and a low refractive index layer provided between the microlens array and the transparent substrate and having a lower refractive index than the transparent substrate.

In the above liquid crystal display apparatus, the backlight unit may further include a light source, and the light guide preferably receives light from the light source through an end, reflects the light by a second prism portion formed on one side surface, and outputs parallel light through a side surface opposite to the side surface on which the second prism portion is formed.

In the above liquid crystal display apparatus, the light source preferably includes a first light source provided at one end of the light guide, and a second light source provided at another end of the light guide.

In the above liquid crystal display apparatus, the side surface of the light guide on which the second prism portion is formed preferably has a curved structure with a projecting center.

Preferably, in the above liquid crystal display apparatus, the microlens is a cylindrical lens lying perpendicular to the reflective groove of the first prism portion.

The liquid crystal display apparatus may further include a polarizing plate or a polarizing layer provided between the low refractive index layer and the microlens array.

In the above liquid crystal display apparatus, it is preferred that the liquid crystal display panel includes a plurality of rectangular pixels arranged adjacent to each other with longitudinal directions of the pixels oriented in the same direction, and a longitudinal direction of the microlens of the backlight unit is oriented parallel with transverse directions of the pixels.

Preferably, the liquid crystal display apparatus is a transflective liquid crystal display apparatus.

The present invention provides a backlight unit capable of improving the brightness of a liquid crystal display panel and a liquid crystal display apparatus using the backlight unit.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a cross-sectional view schematically showing the structure of a liquid crystal display apparatus according to a first embodiment of the present invention;

FIG. 2A is a front view schematically showing the structure of a backlight unit according to the first embodiment of the present invention;

FIG. 2B is a schematic cross-sectional view along line P-P in FIG. 2A;

FIG. 2C is a schematic cross-sectional view along line Q-Q in FIG. 2A;

FIG. 3A is a back view schematically showing the structure of a backlight unit according to the first embodiment of the present invention;

FIG. 3B is a schematic cross-sectional view along line R-R in FIG. 3A;

FIG. 3C is a schematic cross-sectional view along line S-S in FIG. 3A;

FIG. 4 is a view showing an example of a prism portion and a reflective portion;

FIG. 5 is a view showing an example of a prism portion and a reflective portion;

FIG. 6 is an enlarged schematic view of a LED and a light guide;

FIG. 7 is an enlarged schematic view of a microlens array substrate at a light source side;

FIG. 8 is a view showing the relationship between materials of a low refractive index layer and optical characteristics;

FIG. 9 is a perspective view of a backlight unit;

FIG. 10 is an explanatory view showing the physical relationship between a microlens and a pixel;

FIGS. 11A to 11E are views showing a method of manufacturing a microlens array substrate according to the first embodiment of the present invention;

FIG. 12 is a cross-sectional view schematically showing the structure of a liquid crystal display apparatus according to a second embodiment of the present invention;

FIG. 13A is a front view schematically showing the structure of a backlight unit according to the second embodiment of the present invention;

FIG. 13B is a schematic cross-sectional view along line T-T in FIG. 13A;

FIG. 13C is a schematic cross-sectional view along line U-U in FIG. 13A;

FIG. 14A is aback view schematically showing the structure of a backlight unit according to the second embodiment of the present invention;

FIG. 14B is a schematic cross-sectional view along line V-V in FIG. 14A;

FIG. 14C is a schematic cross-sectional view along line W-W in FIG. 14A; and

FIG. 15 is a graph showing simulation of the brightness of a liquid crystal display apparatus using a backlight unit according to an embodiment of the present invention.

### DESCRIPTION OF THE PREFERRED EMBODIMENTS

### First Embodiment

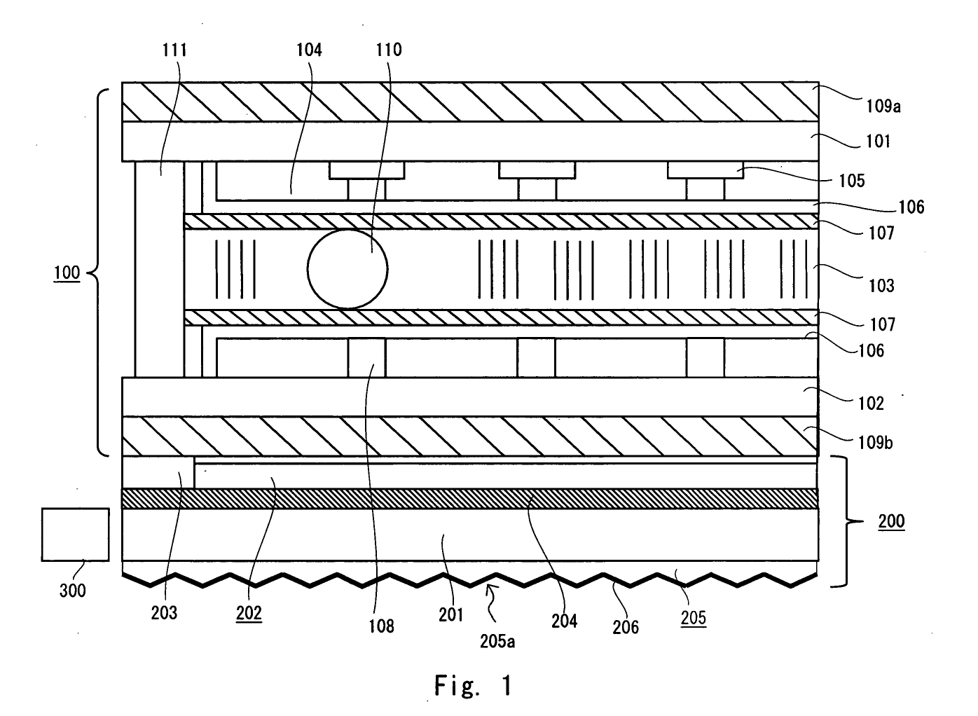

A liquid crystal display apparatus according to a first embodiment of the present invention is described hereinafter with reference to FIG. 1. FIG. 1 is a cross-sectional view schematically showing the structure of the liquid crystal display apparatus according to the first embodiment of the present invention.

As shown in FIG. 1, the liquid crystal display apparatus includes a liquid crystal display panel 100, a microlens array substrate 200, and a light source unit 300. The liquid crystal display apparatus according to an embodiment of the present invention may be used in cellular telephones, mobile terminals, portable game players, car navigation system displays, and so on. The present invention can be applied to transflective and transmissive liquid crystal display apparatus. The backlight unit of the present invention is particularly effective in transflective liquid crystal display apparatus. Where outside light is bright enough, transflective liquid crystal display apparatus utilize the reflection of outside light. Transflective liquid crystal display apparatus thus have a function to reflect outside light. Accordingly, transflective liquid crystal display apparatus have lower backlight transmittance than transmissive liquid crystal display. This embodiment allows backlight to be focused on a transmissive area through a microlens, thus preventing a decrease in light use efficiency. It is therefore possible to enlarge a reflective area and also increase the visibility during the use of outside light.

The microlens array substrate 200 and the light source unit 300 constitute a backlight unit. The liquid crystal display panel 100 includes transparent substrates 101 and 102 with their inner surfaces facing each other. A liquid crystal layer 103 is placed between the inner surfaces of the transparent substrates 101 and 102. A transparent electrode 106 or the like is formed on the inner surfaces of the transparent substrates 101 and 102.

The structure of the liquid crystal display panel 100 is described hereinafter in detail with reference to FIG. 1. As shown in FIG. 1, spacers 110 are scattered between the transparent substrates 101 and 102. The spacer 110 is placed to control the height of the liquid crystal layer 103, which is called a cell gap. The transparent substrates 101 and 102 are adhered to each other by a sealing material 111. The sealing material 111 is applied to the periphery of each of the transparent substrates 101 and 102. Polarizing plates 109a and 109b are placed on the outer surfaces of the transparent substrates 101 and 102, respectively.

The transparent substrate 101 is a thin plate that is rectangular when viewed from above. The transparent substrate 101 is made of a material such as glass, polycarbonate or acrylic resin. On the inner surface of the transparent substrate 101, a color filter layer 104, a transparent electrode 106, and an alignment layer 107 are formed sequentially on top of each other. A black matrix 105, which serves as a light shielding film, is formed between pixels of the color filter layer 104. Each pixel has a transmissive area to allow backlight to pass through. The transmissive area is formed in the area other than a non-transmissive area such as the black matrix 105, a TFT device, and various lines. With the color filter layer 104, the transparent electrode 106, the alignment layer 107 and so on formed on the transparent substrate 101, a device substrate is produced.

The transparent substrate 102 is a rectangular thin plate just like the transparent substrate 101. The transparent substrate 102 is made of a material such as glass, polycarbonate or acrylic resin. On the inner surface of the transparent substrate 102, a TFT device 108, a transparent electrode 106, and an alignment layer 107 are formed sequentially on top of each other. As a result of forming the TFT device 108, the transparent electrode 106, and the alignment layer 107 and so on above the transparent substrate 102, a device substrate is produced. A material of the transparent electrode 106 may be ITO (Indium Tin Oxide) for example. A material of the alignment layer 107 may be a polyimide thin film, for example.

The structure of the microlens array substrate 200 and the light source unit 300 are described hereinafter. As shown in FIG. 1, the microlens array substrate 200 is placed to the backside of the liquid crystal display panel 100. The light source unit 300 is placed to one side of the microlens array substrate 200.

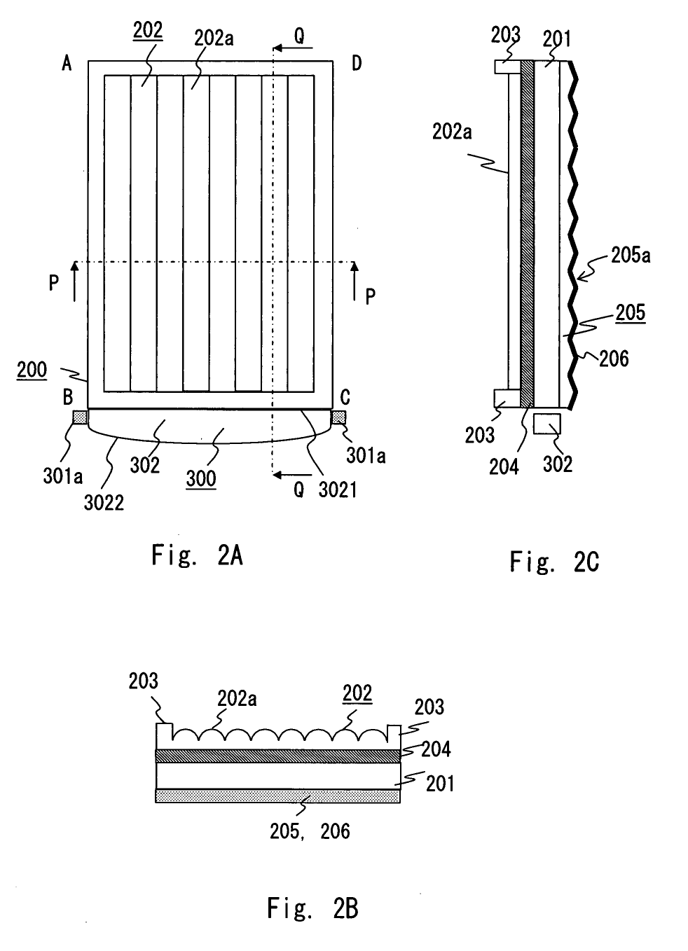

FIG. 2A is a front view schematically showing the structure of a backlight unit according to the first embodiment of the present invention. FIG. 2B is a schematic cross-sectional view along line P-P in FIG. 2A. FIG. 2C is a schematic cross-sectional view along line Q-Q in FIG. 2A.

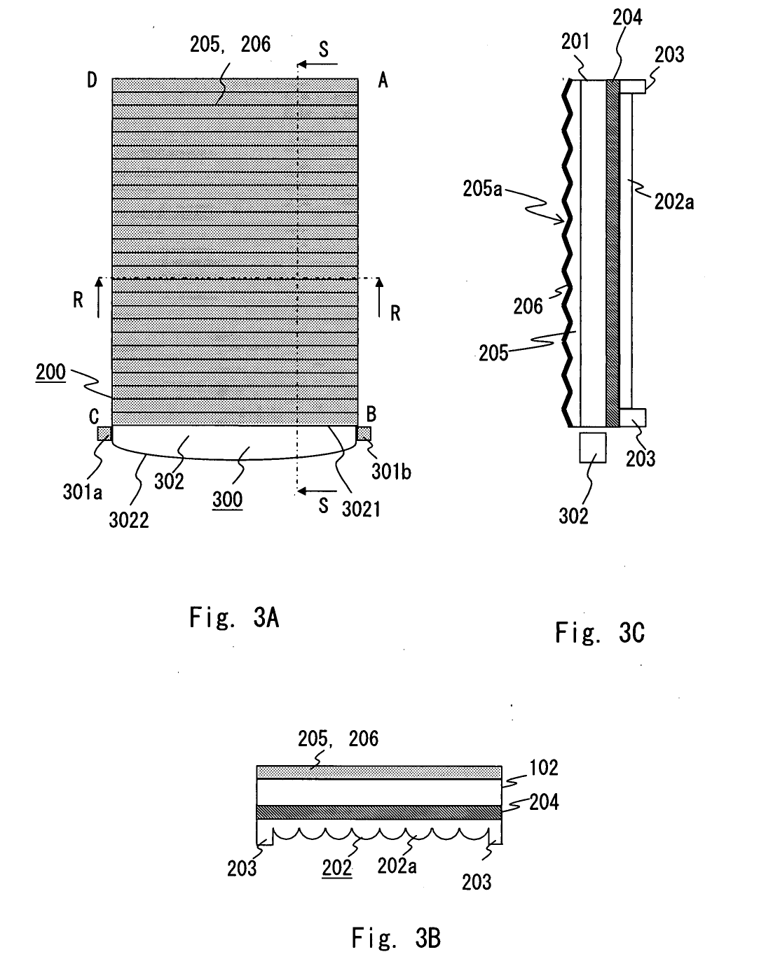

FIG. 3A is a back view schematically showing the structure of a backlight unit according to the first embodiment of the present invention. FIG. 3B is a schematic cross-sectional view along line R-R in FIG. 3A. FIG. 3C is a schematic cross-sectional view along line S-S in FIG. 3A.

In FIG. 2A and FIG. 3A, four corners of a transparent substrate 201 for a microlens array are indicated by the symbols A to D for convenience.

As shown in FIGS. 2A to 3C, the elongated direction (longitudinal direction) of a microlens 202a of a microlens array 202 and the elongated direction (longitudinal direction) of a groove 205a of a prism portion 205 are substantially orthogonal to each other.

As shown in FIGS. 1 to 3C, the microlens array substrate 200 includes the transparent substrate 201, the microlens array 202 including a plurality of microlenses 202a, a rim 203, a low refractive index layer 204, the prism portion 205 including a plurality of grooves 205a, and a reflective portion 206.

The transparent substrate 201 is a substrate that is used to form a microlens array thereon, which is shaped like a rectangular thin plate. The transparent substrate 201 is made of a glass material.

The thermal expansion coefficient of the transparent substrate 201 is preferably close to the thermal expansion coefficient of a glass substrate that is used for the liquid crystal display panel. Specifically, the transparent substrate 201 is preferably a glass substrate with 10*10⁻⁷(/° C.) to 100*10⁻⁷(/° C.). This prevents displacement between a liquid crystal pixel and a microlens array due to environment temperature.

The microlens array 202 and the rim 203 are formed on the front surface of the transparent substrate 201 as shown in FIGS. 1 to 3C. As shown in FIG. 1, the microlens array substrate 200 is attached to the backside of the liquid crystal display panel 100 through the rim 203. The microlens array 202 and the rim 203 are formed by depositing a photosensitive resin (resist) on the transparent substrate 201 and performing exposure and development thereon as described later.

The microlens array 202 includes a plurality of microlenses 202a each having a convex shape with a crescent cross-section. The microlens 202a is a cylindrical lens. The microlens 202a is a barrel-shaped lens having a curvature mainly in one direction only. The microlens 202a, however, may have a curvature in a plurality of different directions. As shown in FIGS. 2A to 3C, the plurality of elongated microlenses 202a are arranged continuously along the side BC of the transparent substrate 201. Thus, each microlens 202a lies substantially perpendicular to the side BC of the transparent substrate 201. The side BC is a part of the edge of the transparent substrate 201 when viewed from above, along which the light source unit 300 is placed.

The width of the microlens 202a is less than several mm to correspond to a pixel of the liquid crystal display panel 100.

As shown in FIGS. 2A to 3C, the rim 203 as an outer frame is formed protruding along the periphery of the microlens array 202. As shown in FIGS. 1 to 3C, the rim 203 has a height that is equal to or larger than the top convex part of the microlens array 202. The rim 203 is formed to attach the microlens array substrate 200 to the backside of the liquid crystal display panel 100.

The prism portion 205 having a plurality of grooves 205a is formed on the backside of the transparent substrate 201. The groove 205a lies substantially parallel with the side BC of the transparent substrate 201. The plurality of grooves 205a are arranged continuously in parallel with each other. The elongated direction (longitudinal direction) of the plurality of grooves 205a is substantially orthogonal to the elongated direction (longitudinal direction) of the plurality of microlenses 202a.

The prism portion 205 may be formed by roll-transfer printing and curing a transparent photocurable resin that is previously patterned with a plurality of prism-shaped grooves 205a and then fixing it onto the transparent substrate 201. The transparent substrate 201 is made of a material such as polyethylene terephthalate (which is referred to hereinafter as PET) or the like. Alternatively, the prism portion 205 may be produced by coating a photoreactive resin directly onto the transparent substrate 201 and then forming a plurality of grooves 205a by photolithography using a gray mask or the like. The prism portion 205 can be created in such a manner.

It is possible to form the prism portion 205 on a transparent base material such as polycarbonate by nanoimprinting using a stamper. It is also possible to form the prism portion 205 directly on the backside of the transparent substrate 201 by 2P process. The refractive index of the prism portion 205 is equal to or larger than the refractive index of the transparent substrate 201.

As shown in FIGS. 1 to 3C, the reflective portion 206 is formed on the surface of the prism portion 205. The reflective portion 206 is made of a material such as gold, silver, aluminum, or aluminum alloy. The reflective portion 206 is formed on the prism portion 205 by vapor deposition or the like. Alternatively, a sheet of gold, silver, aluminum, aluminum alloy or the like may be placed on the prism portion 205. It is also possible to dispose a reflective plate independently separated from the microlens array substrate 200, rather than directly forming a reflective film in the reflective portion 206.

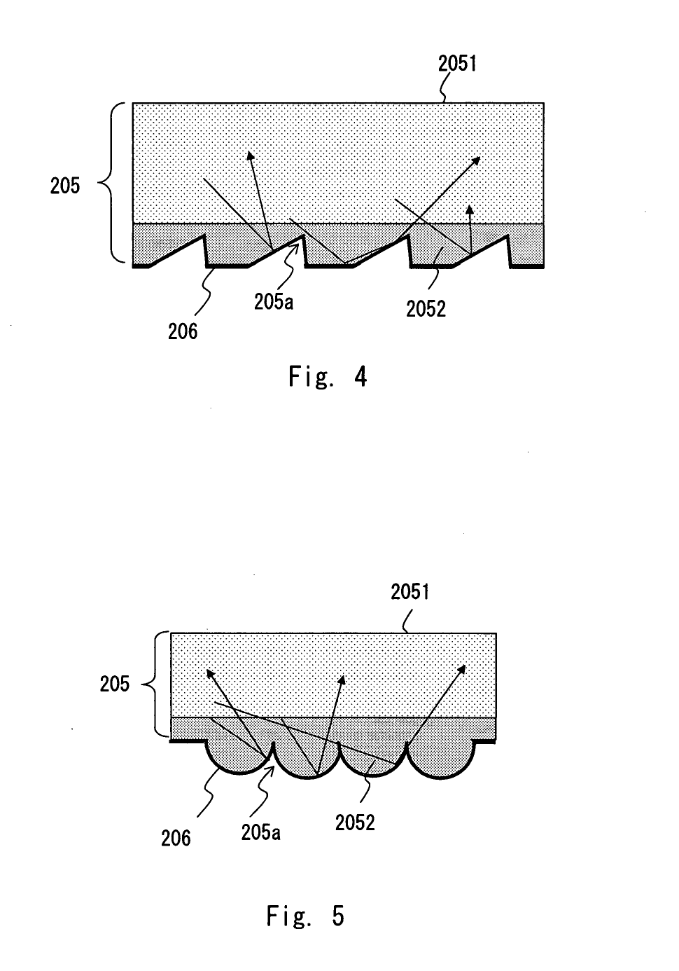

Specific examples of the prism portion 205 and the reflective portion 206 are described hereinafter. FIGS. 4 and 5 show examples of the prism portion and the reflective portion. As shown in FIGS. 4 and 5, the prism portion 205 includes a PET sheet 2051, a photocurable resin 2052 coated on the PET sheet 2051, and a plurality of grooves 205a formed in the photocurable resin 2052. The PET sheet 2051 and the photocurable resin 2052 are made of materials having a refractive index of about 1.6.

In FIG. 4, each of the plurality of groove 205a has a sharp angular edge when viewed in cross section. In FIG. 5, each of the plurality of groove 205a is in between convex crescent shapes when viewed in cross section. As shown in FIGS. 4 and 5, the reflective portion 206 is formed in a thin film form over the surface of the prism portion 205. The reflective portion 206 is made of gold, silver, aluminum, aluminum alloy or the like. Because the reflective portion 206 is formed over the surface of the prism portion 205, light is reflected or scattered at the edge of each groove 205a as shown in FIGS. 4 and 5, so that outgoing light from the prism portion 205 is substantially uniform. As a result, outgoing light with a high uniformity and a wide viewing angle can be obtained. Although not shown, a hardcoat layer is formed on the reflective portion 206. The hardcoat layer is made of light curable resin or the like. The hardcoat layer is placed for protection and anti-oxidation of the reflective portion 206. The prism portion 205 is not necessarily arranged continuously in parallel with the side BC and it may be arranged intermittently.

As shown in FIGS. 2A to 3C, the light source unit 300 may include light emitting diodes (which is referred to hereinafter as LEDs) 301a and 301b and a light guide 302. The light source unit 300 is arranged to face the light incident surface of the light guide 302. The light source unit 300 and the microlens array substrate 200 are arranged with a certain distance away from each other. Air or a low refractive index layer having a lower refractive index than the microlens array substrate 200 maybe placed between the light source unit 300 and the microlens array substrate 200. The LEDs 301a and 301b are point-source light that are placed at both ends (side surfaces at the edges of a shorter side) of the light guide 302.

The light guide 302 may be made of a transparent resin such as polycarbonate, polyolefin, or acrylic resin. The light guide 302 has a side surface 3021 to the side of the microlens array substrate 200. The light guide 302 also has a side surface 3022 to the opposite side of the microlens array substrate 200. A prism-shaped reflective groove is formed on the side surface 3022. Instead, a reflective film may be formed on the side surface 3022. The reflective groove on the side surface 3022 is formed so as to output the light emitted from the LEDs 301a and 301b toward the transparent substrate 201. Further, the reflective groove on the side surface 3022 is formed so as to output the light, which is emitted from the LEDs 301a and 301b and reflected by the side surface 3021, toward the transparent substrate 201. Thus, the reflective groove does not function to guide the light from the incident side through the light guide 302 by repeatedly reflecting the light a plurality of times between the side surface 3021 and the side surface 3022. Therefore, the prism-shaped reflective groove formed on the side surface 3022 of the light guide 302 can more easily increase the directivity of outgoing light compared with the prism-shaped reflective groove formed on the bottom surface of the microlens array substrate 200.

Further, the side surface 3022 of the light guide 302 has a curved surface with a curvature in the longitudinal direction (the direction of the side BC of the transparent substrate 201). Specifically, a curved shape that is convex toward the direction opposite from the propagation direction of the outgoing light from the light guide 302 is formed in the central part of the side surface 3022 of the light guide 302. With such a curved shape, it is possible to increase the directivity of light incident through both ends so as to output the light to the end face of the microlens array substrate along the side surface 3021.

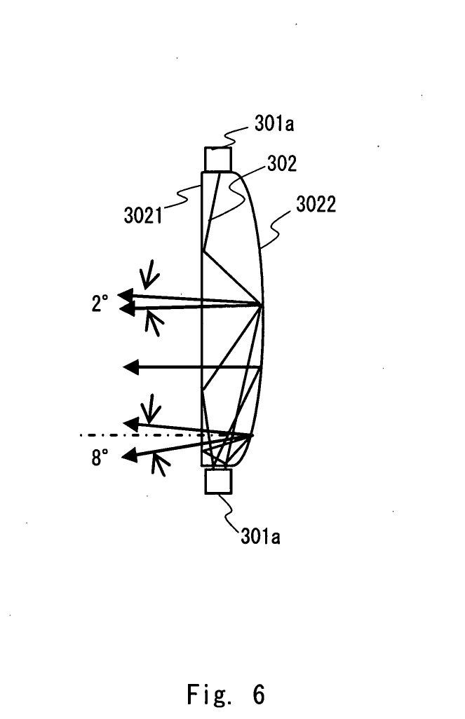

In the curved surface of the light guide 302, the curvature of the central part is smaller than the curvature of the both ends. This enables the directivity of outgoing light from the central part of the light guide 302 to be higher than the directivity of outgoing light from the both ends of the light guide 302. As shown in FIG. 6, the outgoing light from the central part has the directivity at an angle of about ±2 at half-width, and the outgoing light from the both ends has the directivity at an angle of about ±8 at half-width.

The light guide 302 can thereby output highly directional light from the side surface 3021 serving as a light output surface. Specifically, the light output from the side surface 3021 of the light guide 302 is parallel light in which the component that progresses from the side surface 3021 along the axis perpendicular to the longitudinal direction of the light guide 302 is high. The angle at half-width of the light output from the light guide 302 is preferably ±15 or less, and more preferably ±10 or less. In this description, the term “parallel light” refers to light that is directional at an angle of ±15 or less at half-width. In this description, the angle of light at half the peak intensity of light that is output from the side surface 3021 of the light guide 302 is called a half-width angle.

As shown in FIGS. 1 to 3C, the low refractive index layer 204 as an intermediate layer is formed between the microlens array 202 and the transparent substrate 201. The low refractive index layer 204 is placed on the front surface of the transparent substrate 201. The refractive index of the transparent substrate 201 is larger than the refractive index of the low refractive index layer 204. The low refractive index layer 204 may be formed by depositing a material containing fluorine resin or hollow nanosilica spheres dispersed in a transparent resin such as acryl onto the front surface of the transparent substrate 201. The hollow nanosilica sphere is a silica (SiO₂) ball of about 40 nm with a hollow internal cavity. Dispersing the hollow nanosilica spheres into a transparent resin can effectively decrease the refractive index of the transparent resin.

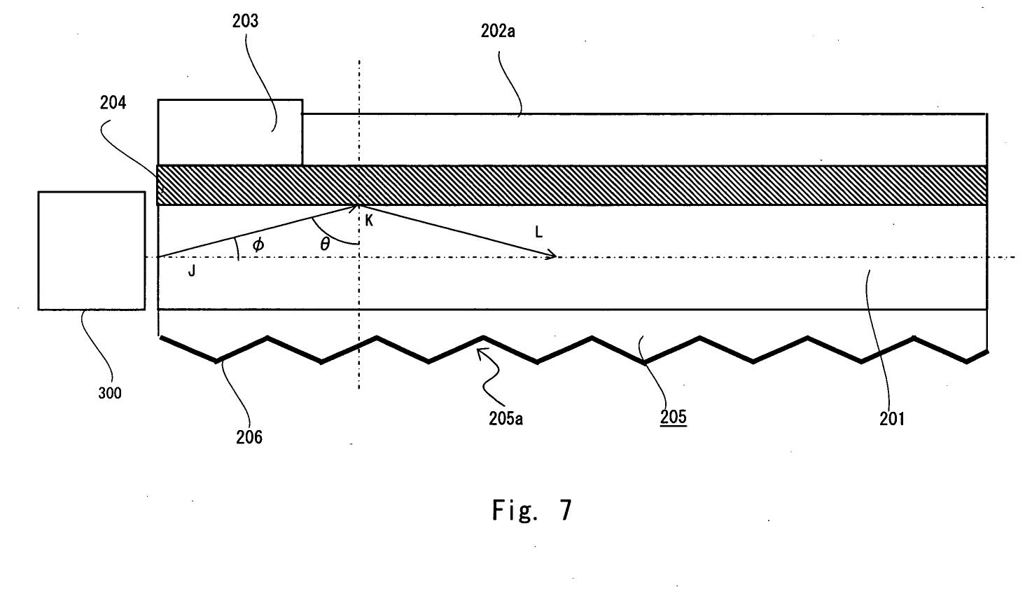

With such a structure, the critical angle θmax of total reflection at the interface between the transparent substrate 201 and the low refractive index layer 204 can be low as described later with reference to FIG. 7. It is thereby possible to reflect the light with a large incidence angle to the microlens 202a by the low refractive index layer 204 to prevent the light with a large incidence angle to the microlens 202a from passing through the interface between the transparent substrate 201 and the low refractive index layer 204. Therefore, the light emitted from the light source unit 300 is efficiently guided through the microlens array substrate 200 and efficiently output through the front surface of the microlens array substrate 200. As a result, the brightness of the pixels in the liquid crystal display panel 100 can be high, and a wide viewing angle is achieved.

If the low refractive index layer 204 is not provided, the light emitted from the light guide 302 is reflected to various directions by the lens surface of the microlens 202a and thus has lower directivity. In this embodiment, the incident parallel light is totally reflected by the flat low refractive index layer 204 to be guided over the whole area. The incident parallel light thus propagates while maintaining the same state, thus suppressing a decrease in directivity. During the propagation, the incident light is reflected by the prism-shaped reflective groove formed on the bottom surface of the microlens array substrate 200. Because the reflective groove is oriented perpendicular to the propagation direction of incident light, the state of the parallel light is not disturbed by the reflection.

The critical angle θmax of total reflection at the interface between the transparent substrate 201 and the low refractive index layer 204 can be specifically calculated as follows. FIG. 7 is an enlarged schematic view of the microlens array substrate at the light source side. The symbol “θ” indicates an angle of incidence of light from the light source unit 300 to the low refractive index layer 204. The symbol “φ” indicates an angle of refraction of light from the light source unit 300 upon entering the transparent substrate 201 from an air layer. The arrows JK and KJ in FIG. 7 indicate the optical path of light from the light source unit 300 upon total reflection at the interface between the transparent substrate 201 and the low refractive index layer 204.

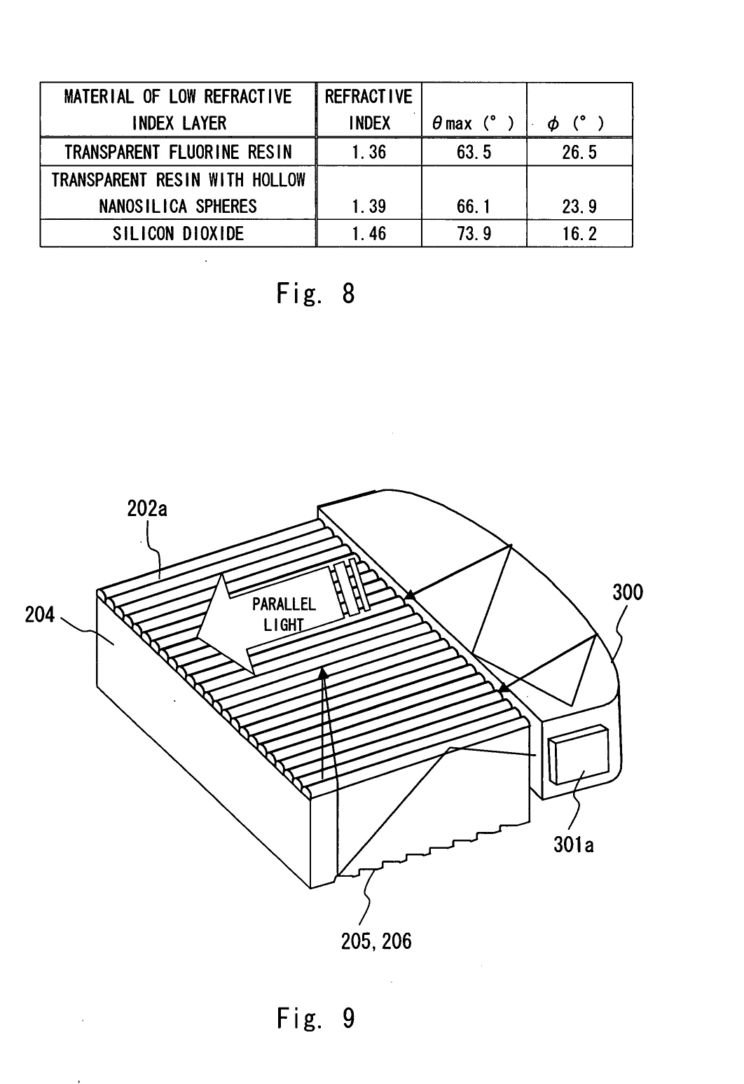

FIG. 8 is a view showing the relationship between materials of a low refractive index layer and optical characteristics. As shown in FIG. 8, a transparent fluorine resin, a transparent resin containing hollow nanosilica spheres, and silicon dioxide are selected as a material of the low refractive index layer 204. According to Snell's Law, total reflection conditions are such that the critical angle θmax of total reflection at the interface between the transparent substrate 201 and the low refractive index layer 204 is smaller as the refractive index of the low refractive index layer 204 is lower.

As shown in FIG. 8, if the transparent fluorine resin with the lowest refractive index is selected, the critical angle θmax of total reflection can be as low as about 63.5°. In this case, a refraction angle φ of light from the light source unit 300 upon entering the transparent substrate 201 from an air layer is about 26.5°. In this study of total reflection conditions according to Snell's Law, the refractive index of the transparent substrate 201 is set 1.52.

As the refraction angle φ is larger, the light with a large incidence angle to the microlens 202a is more efficiently reflected by the low refractive index layer 204 to thereby efficiently prevent the light with a large incidence angle to the microlens 202a from passing through the interface between the transparent substrate 201 and the low refractive index layer 204. It is therefore possible to reduce an incidence angle of the light that actually enters the microlens 202a, so that the light emitted from the light source unit 300 which is placed next to the side surface of the microlens array substrate 200 is efficiently output through the front surface of the microlens array substrate 200.

As described above, a liquid crystal display apparatus that includes the microlens array substrate 200 which is provided with a function as a light guide plate of backlight is obtained. This eliminates the need for a light guide plate and a plurality of optical sheets, which are used in conventional liquid crystal display apparatus. It is thereby possible to reduce the thickness of a backlight unit and accordingly reduce the thickness of a liquid crystal display apparatus as a whole. Further, the elimination of a light guide plate and a plurality of optical sheets leads to a decrease in parts costs and manufacturing costs.

If, for example, the thickness of a liquid crystal display panel including a polarizing plate is about 0.6 mm, the thickness of a microlens array substrate is about 0.3 mm, the thickness of a light guide plate is about 0.4 mm, and the total thickness of a plurality of optical sheets is about 0.25 mm, the thickness of an entire liquid crystal display apparatus is about 1.55 mm according to related arts. On the other hand, in the liquid crystal display apparatus according to the first embodiment of the present invention, if the thickness of a liquid crystal display panel including a polarizing plate is about 0.6 mm and the thickness of a microlens array substrate is about 0.4 mm, the thickness of the entire liquid crystal display apparatus is about 1.0 mm. The present invention can thus reduce the thickness of the entire liquid crystal display apparatus by about 0.55 mm.

With the recent development of thin liquid crystal display panels, the rigidity of liquid crystal display panels decreases to cause the liquid crystal display panels to be easily broken. However, because the microlens array substrate 200 is placed to the backside of the liquid crystal display panel 100 in this embodiment, the rigidity of the entire liquid crystal display apparatus is enhanced. In addition, because the microlens array substrate 200 is adhered to the back surface of the liquid crystal display panel 100 through the rim 203, the rigidity of the entire liquid crystal display apparatus can be further enhanced.

FIG. 9 is a perspective view of a backlight unit according to the first embodiment of the present invention. Referring to FIG. 9, the behavior of the light emitted from the LED 301a to be output through the output surface of the microlens array substrate 200 is described hereinafter.

The light emitted from the LED 301a enters the light guide 302 through its end. In the light guide 302, the incident light is reflected by the side surface 3022 having the prism-shaped reflective groove either directly or after being reflected by the side surface 3021 and then output through the side surface 3021 to the side of the microlens array substrate 200. The outgoing light is parallel light with a high directivity perpendicular to the longitudinal direction of the side surface 3021 as an output surface.

The parallel light that is incident on the microlens array substrate 20 through its side surface is incident on the microlens 202a either after being reflected between the low refractive index layer 204 and the prism portion 205 or immediately after being reflected once by the prism portion 205. The state of the parallel light is not disturbed when it is reflected by the reflective groove of the prism portion 205 and the light maintains high directivity. This is because the reflective groove of the prism portion 205 lies perpendicular to the propagation direction of the parallel light. Further, the state of the parallel light is not disturbed when it is reflected by the low refractive index layer 204 and the light maintains high directivity. This is because the low refractive index layer 204 has a flat interface.

The parallel light that enters the microlens 202a is focused accurately in accordance with the lens shape of the microlens 202a in the direction perpendicular to the longitudinal direction of the microlens 202a. The parallel light is thus focused perpendicularly to the longitudinal direction of the microlens 202a.

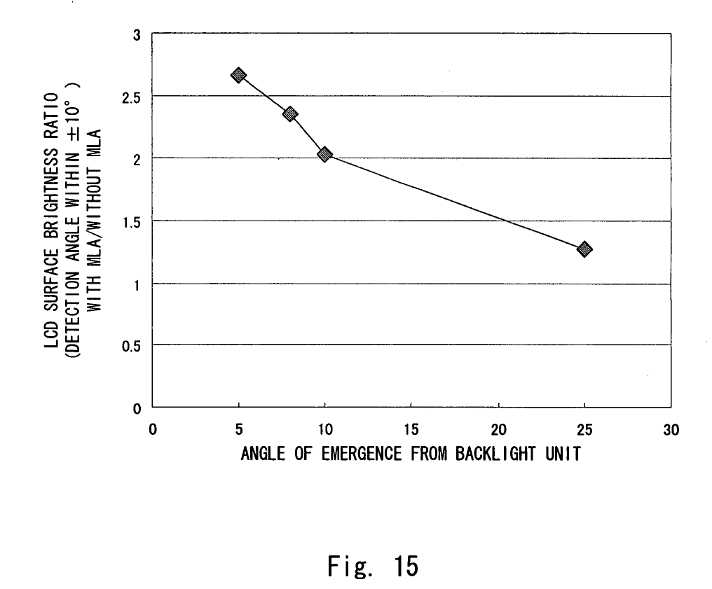

FIG. 15 shows the simulation of the brightness of the liquid crystal display apparatus using the backlight unit according to this embodiment. The graph tells that the brightness increases as an output angle of light from the light source is smaller; i.e. as the light is closer to parallel.

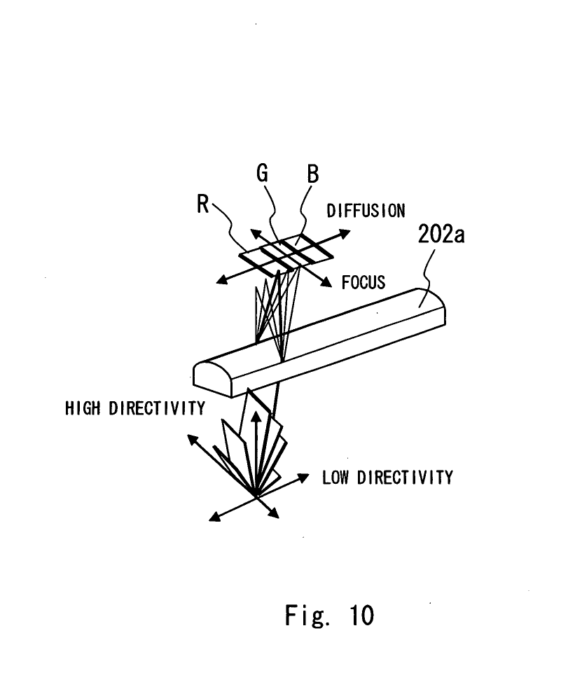

Referring now to FIG. 10, a pixel on the liquid crystal display panel has a rectangular shape and arranged with its long side adjacent to a long side of a next pixel. For example, a QVGA pixel has a long side of 150 μm and a short side of 50 μm. A VGA pixel has a long side of 75 μm and a short side of 25 μm. These pixels have a smaller numerical aperture along the long side than the short side. Therefore, the incident light passes through the aperture more efficiently when it is focused accurately along the long side, rather than it is focused accurately along the short side. And, therefore brightness is increased. Thus, the pixel is arranged such that its long side lies perpendicular to the longitudinal direction of the microlens 202a, which enables accurate focusing, as shown in FIG. 10. The incident light is diffused after being focused on a transmissive area of a pixel and therefore a viewing angle along the long side of the pixel is wide.

Although the light is less directional in the longitudinal direction of the microlens 202a, this direction corresponds to the direction of the short side with a large numerical aperture and thus it does not cause a significant decrease in brightness. This embodiment ensures a wide viewing angle along the short side of the pixel by setting the light to have a low directivity.

In this manner, the light emitted from the LED 301a is output from the microlens 202a to enter each pixel. It is thereby possible to avoid TFT devices and black matrixes formed on the liquid crystal display panel accurately to increase the brightness of the liquid crystal display panel.

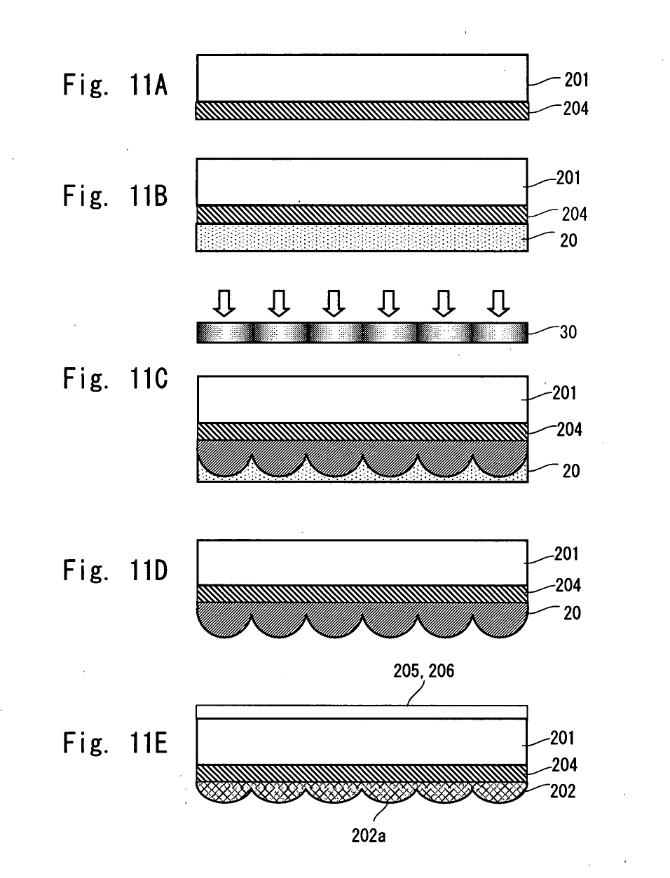

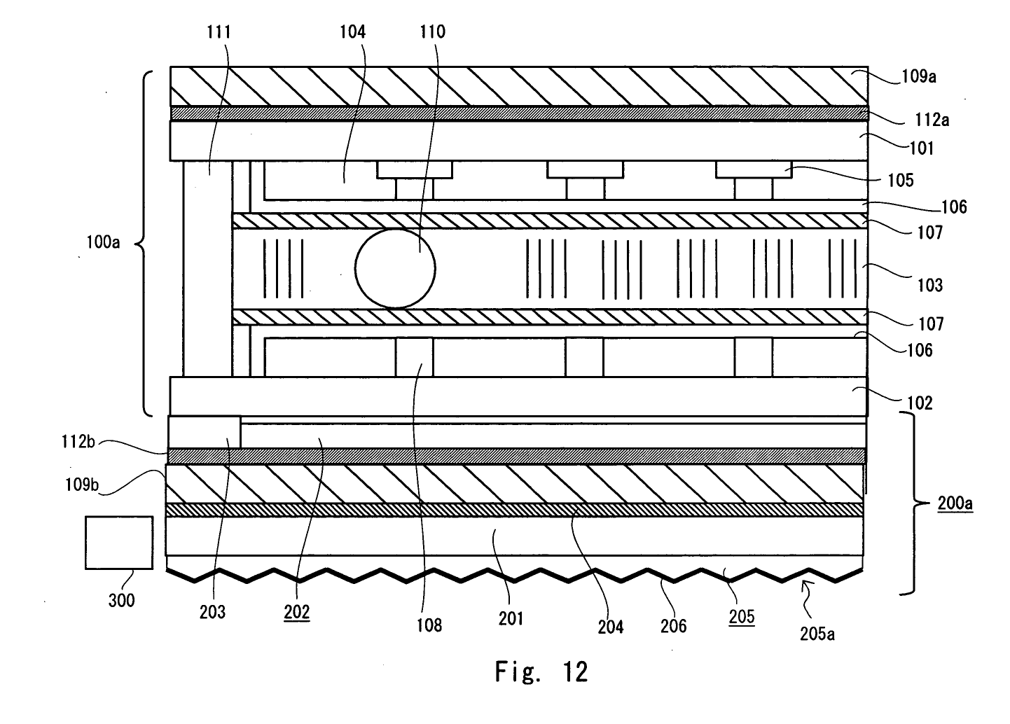

A method of manufacturing a microlens array substrate according to the first embodiment of the present invention is described hereinafter. FIGS. 11A to 11E show a manufacturing method of a microlens array substrate according to the first embodiment of the present invention.

Referring to FIG. 11A, the transparent substrate 201 that is made of glass is prepared. The front surface of the transparent substrate 201 is then coated with a transparent fluorine resin, for example. The low refractive index layer 204 is thereby formed. The transparent substrate 201 may be a glass substrate with the thickness of 400 μm, for example.

Referring then to FIG. 11B, a photosensitive resin (transparent negative resist) is coated all over the surface of the transparent substrate 201 on which the low refractive index layer 204 is formed. A lens formation layer 20 is then formed using a grayscale mask. The resist may be deposited by spin coating, slit coating or the like.

The photosensitive resin is preferably a UV curable resin. It is preferred to use a material that can be developed with organic solvent, alkaline solution, or water for the photosensitive resin. A UV curable resin preferably contains an acrylic copolymer at least having at the side chain a carboxyl group and an ethylene unsaturated group and a photoreactive compound. The acrylic copolymer that has a carboxyl group and an ethylene unsaturated group at the side chain is a polymer binder, which can be obtained by adding an ethylene unsaturated group at the side chain of an acrylic copolymer that is copolymerized from unsaturated carboxylic acid and ethylene unsaturated compound.

The unsaturated carboxylic acid may be acrylic acid, methacrylic acid, itaconic acid, crotonic acid, acid anhydride of these, or the like. The ethylene unsaturated compound may be methyl acrylate, methyl methacrylate, ethyl acrylate or the like. The ethylene unsaturated group at the side chain may be a vinyl group, an allyl group, an acrylic group, or the like.

The ethylene unsaturated compound having a glycidyl group maybe glycidyl acrylate, glycidyl methacrylate, allyl glycidyl ether, or the like. As the photosensitive resin, a photosensitive polymer or a nonphotosensitive polymer may be used as a polymer binder instead of the acrylic copolymer described above.

The photosensitive polymer involves a photo-insoluble type and a photo-soluble type. The photo-insoluble type includes a mixture of a functional monomer or oligomer having one or more unsaturated group per molecule with an appropriate polymer binder, a mixture of a photosensitive compound such as an aromatic diazo compound, an aromatic azide compound or an organic halogen compound with an appropriate polymer binder, a photosensitive macromolecule of an existing macromolecule with a pendant photosensitive group or its modified version, a so-called diazo resin such as a condensate of diazo amine and formaldehyde, or the like. The photo-soluble type includes a complex of a diazo compound with mineral salts or organic acid, a mixture of quinine azide or the like with an appropriate polymer binder, a product of binding quinine diazo with an appropriate polymer binder, such as naphthoquinone-1, 2-diazido-5-sulfonic ester of phenol, novolak resin, or the like.

The nonphotosensitive polymer includes polyvinyl alcohol, polyvinyl butyral, methacrylate ester polymer, acrylic ester polymer, acrylic ester-methacrylate ester copolymer, a-methyl styrene copolymer or the like.

As the photoreactive compound, a monomer/oligomer containing carbon-carbon unsaturated bonds with known photoreactivity may be used. For example, the photoreactive compound may be acryl acrylate, benzyl acrylate, butoxyethyl acrylate, butoxytriethylene glycol acrylate, or the like. Typical oligomers are polyester acrylate, urethane acrylate, epoxy acrylate, and so on.

A photopolymerization initiator that is used for a UV curable resin may be a combination of benzophenone, o-benzoyl methyl benzoate, 4,4-bis(dimethylamine)benzophenone, 4,4-bis(diethylamino)benzophenone, 4,4-dichlorobenzophenone or the like with reducing agents.

Referring then to FIG. 11C, a grayscale mask 30 is placed to the opposite side of the surface of the transparent substrate 201 on which the lens formation layer 20 is formed, and exposure is performed onto the lens formation layer 20. The grayscale mask 30 is formed corresponding to the shapes of the microlens array 202 and the rim 203 shown in FIGS. 2A to 3C. The intensity of exposure light that is applied through the grayscale mask 30 in the formation area of the microlens array 202 is modified by the grayscale mask 30.

Specifically, the intensity of exposure light is modified in the formation area of each microlens 202a such that the exposure intensity is maximum at the center and gradually decreases toward the both ends of each microlens 202a. By the exposure light with the modified intensity in the lens formation area of the grayscale mask 30, the lens formation layer 20 is cured into a lens convex shape with a crescent cross-section.

Further, the formation area of the rim 203 is also exposed using the grayscale mask 30 to be cured into a rim shape. The simultaneous formation of the plurality of microlenses 202a and the rim 203 using the same grayscale mask 30 enables efficient formation of the microlens array 202 and the rim 203 on the transparent substrate 201.

Referring then to FIG. 11D, after the exposure of the lens formation layer 20, development is performed on the lens formation layer 20 to remove the uncured part. Because the area other than the formation area of the microlens array 202 and the rim 203 is not exposed nor developed, the lens formation layer 20 is completely removed in this area. The microlens array 202 and the rim 203 are thereby formed on the transparent substrate 201. The height of the convex-crescent-shaped microlens 202a may be about 15 μm and the height of the rim 203 may be about 20 μm, for example.

Referring to FIG. 11E, the prism portion 205 and the reflective portion 206 are formed on the surface of the transparent substrate 201 opposite to the surface having the microlens array 202. Specifically, the prism portion 205 with the reflective portion 206 formed on its surface is fixed onto the surface of the transparent substrate 201 that is opposite to the surface on which the microlens array 202 is formed. Further, a hardcoat layer (not shown) is formed on the reflective portion 206. A photocurable resin or the like may be used as a material of the hardcoat layer. The hardcoat layer is placed for protection and anti-oxidation of the reflective portion 206.

The prism portion 205 may be formed by roll-transfer printing and curing a transparent photocurable resin that is previously patterned with a plurality of prism-shaped grooves 205a on a transparent base material such as PET and then fixing it onto the transparent substrate 201. The reflective portion 206 is formed by vapor-depositing gold, silver, aluminum, aluminum alloy or the like onto the surface of the prism portion 205.

The microlens array substrate 200 is produced as described above.

### Second Embodiment

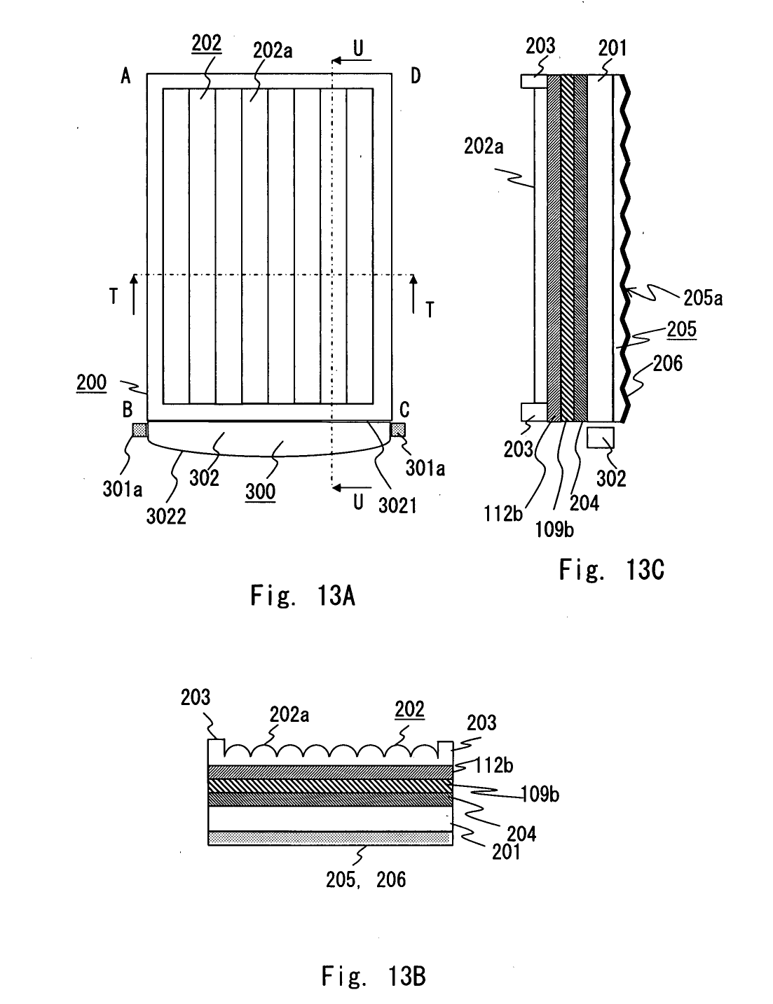

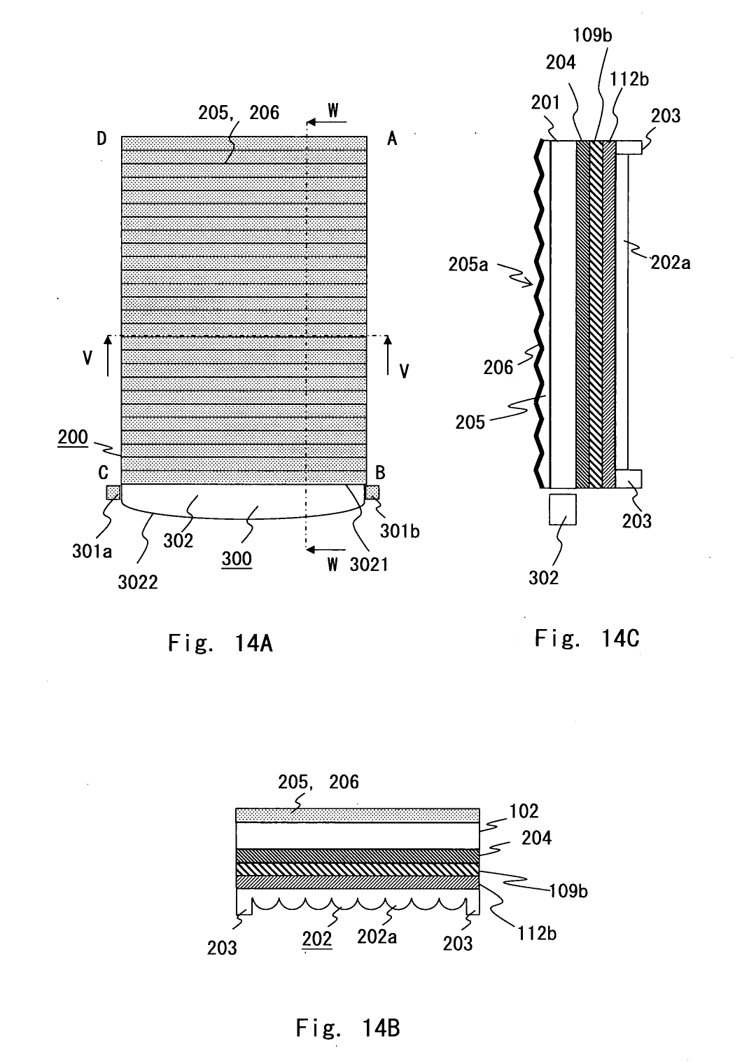

A liquid crystal display apparatus according to a second embodiment of the present invention is described hereinafter. FIG. 12 is a cross-sectional view schematically showing the structure of the liquid crystal display apparatus according to the second embodiment of the present invention. FIGS. 13A to 13C are schematic views showing the structure of a microlens array substrate and a light source according to the second embodiment of the present invention. FIG. 13A is a schematic front view, FIG. 13B is a schematic cross-sectional view along line T-T in FIG. 13A, and FIG. 13C is a schematic cross-sectional view along line U-U in FIG. 13A.

FIGS. 14A to 14C are schematic views showing the structure of a microlens array substrate and a light source according to the second embodiment of the present invention. FIG. 14A is a schematic back view, FIG. 14B is a schematic cross-sectional view along line V-V in FIG. 14A, and FIG. 14C is a schematic cross-sectional view along line W-W in FIG. 14A.

In the liquid crystal display apparatus according to the first embodiment of the invention, the polarizing plates 109a and 109b are placed on the outer surfaces of the transparent substrates 101 and 102, respectively, of the liquid crystal display panel 100 as shown in FIGS. 1 to 3C. On the other hand, in the liquid crystal display apparatus according to the second embodiment of the invention, the polarizing plate 109b is placed between the low refractive index layer 204 and the microlens array 202 of a microlens array substrate 200a as shown in FIGS. 14A to 14C. Further, λ/4 plate 112b is placed between the microlens array 202 and the polarizing plate 109b. A λ/4 plate 112a is placed between the polarizing plate 109a and the transparent substrate 101 of a liquid crystal display panel 100a.

Such a configuration reduces the distance between the microlens array 202 and the transparent substrate 102 of the liquid crystal display panel 100a to thereby shorten the focal length of the microlens 202a. This enables a wider viewing angle of the liquid crystal display panel 100a. For example, if the thickness of the transparent substrate 102 is 0.2 mm, a viewing angle can be widened to about ±40°.

A method of manufacturing the microlens array substrate 200a according to the second embodiment of the present invention is described hereinafter. In the first place, the low refractive index layer 204, the polarizing plate 109b, the λ/4 plate 112b are deposited sequentially on the transparent substrate 201. Subsequently, the lens formation layer 20 is formed on the λ/4 plate 112b. After that, the microlens array 202, the rim 203 and so on are formed according to the manufacturing method shown in FIG. 8.

The description provided in the foregoing merely illustrates the embodiments of the present invention, and the present invention is not limited to the above-described embodiments. A person skilled in the art will be able to easily change, add, or modify various elements of the above-described embodiments, without departing from the scope of the present invention.

The low refractive index layer 204 is placed between the transparent substrate 201 and the microlens array 202 in the above-described embodiments. However, if the refractive index of the transparent substrate 201 itself is larger than that of the microlens array 202, there is no need to place the low refractive index layer 204.

Further, although a negative photoresist is used in the above-described embodiments, a positive photoresist, in which a photosensitive part is dissolved and the solubility to a solvent is increased, may be used instead.

Furthermore, although the microlens array and the rim are made of the same material in the above-described embodiments, the microlens array and the rim may be made of different materials.

The microlens array and the rim are formed using the same grayscale mask in the above-described embodiments; however, they may be formed using different grayscale masks. The rim is formed on the transparent substrate for microlens array formation in the above embodiments; however, the rim may be formed independently. Although the microlens array substrate 200 is used for a liquid crystal display panel in the above-described embodiments, it may be used for other applications.

Although the LED 301 is placed at both ends of the light guide, it may be placed either one side.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A backlight unit provided at a backside of a liquid crystal display panel and including a microlens for focusing light on a transmissive area of each pixel of the liquid crystal display panel, comprising:
a light guide for outputting parallel light; and
a microlens array substrate for receiving parallel light output from the light guide through a side surface, reflecting the light by a first prism portion formed on a bottom surface, and outputting the light to the liquid crystal display panel through the microlens formed on a front surface, the microlens array substrate comprising:
a microlens array including a plurality of microlenses;
a transparent substrate including the first prism portion having a reflective groove lying perpendicular to a propagation direction of parallel light entering through the side surface; and
a low refractive index layer provided between the microlens array and the transparent substrate and having a lower refractive index than the transparent substrate.

2. The backlight unit according to claim 1, further comprising:
a light source,
wherein the light guide receives light from the light source through an end, reflects the light by a second prism portion formed on one side surface, and outputs parallel light through a side surface opposite to the side surface on which the second prism portion is formed.

3. The backlight unit according to claim 2, wherein the light source comprises:
a first light source provided at one end of the light guide; and
a second light source provided at another end of the light guide.

4. The backlight unit according to claim 2, wherein
the side surface of the light guide on which the second prism portion is formed has a curved structure with a projecting center.

5. The backlight unit according to claim 1, wherein
the microlens is a cylindrical lens lying perpendicular to the reflective groove of the first prism portion.

6. The backlight unit according to claim 1, further comprising:
a polarizing plate or a polarizing layer provided between the low refractive index layer and the microlens array.

7. A liquid crystal display apparatus comprising:
a liquid crystal display panel including liquid crystal interposed between a pair of device substrates with electrodes formed on inner surfaces; and
a backlight unit provided at a backside of the liquid crystal display panel, the backlight unit comprising:
a light guide for outputting parallel light; and
a microlens array substrate for receiving parallel light output from the light guide through a side surface, reflecting the light by a first prism portion formed on a bottom surface, and outputting the light to the liquid crystal display panel through a microlens formed on a front surface, the microlens array substrate comprising:
a microlens array including a plurality of microlenses;
a transparent substrate including the first prism portion having a reflective groove lying perpendicular to a propagation direction of parallel light entering through the side surface; and
a low refractive index layer provided between the microlens array and the transparent substrate and having a lower refractive index than the transparent substrate.

8. The liquid crystal display apparatus according to claim 7, wherein
the backlight unit further comprises a light source, and
the light guide receives light from the light source through an end, reflects the light by a second prism portion formed on one side surface, and outputs parallel light through a side surface opposite to the side surface on which the second prism portion is formed.

9. The liquid crystal display apparatus according to claim 8, wherein the light source comprises:
a first light source provided at one end of the light guide; and
a second light source provided at another end of the light guide.

10. The liquid crystal display apparatus according to claim 8, wherein
the side surface of the light guide on which the second prism portion is formed has a curved structure with a projecting center.

11. The liquid crystal display apparatus according to claim 7, wherein
the microlens is a cylindrical lens lying perpendicular to the reflective groove of the first prism portion.

12. The liquid crystal display apparatus according to claim 7, further comprising:
a polarizing plate or a polarizing layer provided between the low refractive index layer and the microlens array.

13. The liquid crystal display apparatus according to claim 7, wherein
the liquid crystal display panel comprises a plurality of rectangular pixels arranged adjacent to each other with longitudinal directions of the pixels oriented in the same direction, and
a longitudinal direction of the microlens of the backlight unit is oriented parallel with transverse directions of the pixels.

14. The liquid crystal display apparatus according to claim 7, wherein
the liquid crystal display apparatus is a transflective liquid crystal display apparatus.
